(19) United States
(12) Patent Application Publication
(10) Pub. No.: US 2022/0309343 A1
(43) Pub. Date: Sep. 29, 2022

(54) ALWAYS-ON LOCAL ACTION CONTROLLER FOR LOW POWER, BATTERY-OPERATED AUTONOMOUS INTELLIGENT DEVICES

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Daniel Schoch, Irvine, CA (US)

(21) Appl. No.: 17/656,201

(22) Filed: Mar. 23, 2022

Related U.S. Application Data
(63) Continuation-in-part of application No. 17/675,947, filed on Feb. 18, 2022.
(60) Provisional application No. 63/164,813, filed on Mar. 23, 2021.

(51) Int. Cl. G06N 3/08

(52) U.S. Cl. CPC G06N 3/08

(57) ABSTRACT

An always-on local action controller has one or more sensors each receptive to an external input. The respective external inputs are translatable to corresponding signals. One or more always-on data analytic neural network subsystems are each connected to a respective one of the sensors and are receptive to the signals outputted therefrom. An event detection is raised by a given one of the always-on data analytical neural network subsystems in response to a pattern of signal data corresponding to an event. A decision combiner is connected to each of the one or more always-on data analytic neural network subsystems, which generates an action signal based upon an aggregate of the events.

### CROSS-REFERENCE TO RELATED APPLICATIONS

This application is a continuation-in-part of U.S. patent application Ser. No. 17/675,947 filed Feb. 18, 2022 and entitled “ALWAYS-ON WAKE ON MULTI-DIMENSIONAL PATTERN DETECTION FROM SENSOR FUSION CIRCUITRY”, which relates to and claims the benefit of U.S. Provisional Application No. 63/151,250 filed Feb. 19, 2021 and entitled “ALWAYS-ON WAKE ON MULTI-DIMENSIONAL PATTERN DETECTION (WOMPD) FROM A SENSOR FUSION CIRCUITRY,” and further relates to and claims the benefit of U.S. Provisional Application No. 63/164,813 filed Mar. 23, 2021 and entitled “NOVEL USE CASES AND METHODS FOR LOW POWER BATTERY-OPERATED, AUTONOMOUS INTELLIGENT DEVICES UTILIZING AN ALWAYS-ON LOCAL DATA ANALYTICS AND ACTION CONTROLLER AT THE EDGE”, the entire disclosure of each of which are wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces, and specifically novel use cases and methods for low power, battery operated autonomous intelligent devices utilizing an always-on local data analytics and action controller at the edge.

### 2. Related Art

Virtual assistant systems are incorporated into a wide variety of consumer electronics devices, including smartphones/tablets, personal computers, wearable devices, smart speaker devices such as Amazon Echo, Apple HomePod, and Google Home, as well as household appliances and motor vehicle entertainment systems. In general, virtual assistants enable natural language interaction with computing devices regardless of the input modality, though most conventional implementations incorporate voice recognition and enable hands-free interaction with the device. Examples of possible functions that may be invoked via a virtual assistant include playing music, activating lights or other electrical devices, answering basic factual questions, and ordering products from an e-commerce site. Even within individual mobile applications installed on smartphones/tablets, there may be dedicated virtual assistants specific to the application that assist the user with, for example, navigating bank, credit card, and other financial accounts. Beyond virtual assistants incorporated into communications devices such as smartphones and smart speakers, there are a wide range of autonomous devices that capture various environmental inputs and responsively performing an action.

For power conservation and privacy reasons, particularly in battery-powered devices, conventional autonomous systems do not constantly monitor and process all inputs to the underlying device to determine whether one of the functions has been invoked. Always-on sensing with data therefrom being provided to a local action controller may lack accuracy due to power consumption limits, which in turn the processing capabilities. Typically, it is necessary for the autonomous device to connect to a remote/cloud-based system once the local circuitry detects an event of interest by monitoring one input or a sequence of inputs that match a targeted wake condition. In the context of virtual assistants, the system may monitor for the utterance of a wake word as captured by the microphone, such as “Hi AON,” “Hey Siri,” “Hey Google,” “Hey Alexa” and the like. In the case of a smart phone, other than voice activation, the motion applied to the device as captured by onboard accelerometers/gyroscopes may be monitored for a sequence of motion data corresponding to the user holding up the device. Visual data, such as that captured by an onboard camera, may be monitored for the face of the user, and upon a positive facial recognition, the device or virtual assistant may be awoken. The commands immediately following the wake word when the system has been partially awoken may be captured and transmitted to the remote system. On the remote system, the captured input command data may be processed, with the results of the command execution being transmitted back to the local system/device.

There is accordingly a need in the art for autonomous, low-power devices that are capable of making decisions and take actions to control other devices without the need for communication with a remote or cloud system, or for human intervention.

### BRIEF SUMMARY

The embodiments of the present disclosure contemplate an always-on local action controller for low power, battery-operated autonomous intelligent devices without relying on remote computing resources. The action controller is contemplated to achieve high accuracy at ultra-low power, which allows more local autonomy in battery-operated devices at the edge. In various embodiments of the disclosure, there may be an always-on data analytic neural network with deep learning multi-class classifiers.

According to one embodiment, there may be an always-on local action controller. The controller may include one or more sensors that are each receptive to an external input. The respective external inputs may be translatable to corresponding signals. The controller may further include one or more always-on data analytic neural network subsystems that are each connected to a respective one of the one or more sensors and are receptive to the signals outputted therefrom. An event detection may be raised by a given one of the always-on data analytical neural network subsystems in response to a pattern of signal data corresponding to an event. There may also be a decision combiner that is connected to each of the one or more always-on data analytic neural network subsystems. An action signal may be generated based upon an aggregate of the events provided thereby.

Another embodiment is directed to a method for outputting an action command from an always-on controller. The method may include receiving one or more external inputs on respective ones of sensors. The external inputs may be converted to corresponding signals thereby. There may also be a step of detecting one or more events from the signals of the external inputs on a respective one of always-on data analytic neural network subsystems. The method may further include combining the detected events to generate an action signal based upon an aggregate of the detected events. This method may also be performed with one or more programs of instructions executable by the computing device, with such programs being tangibly embodied in a non-transitory program storage medium.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an exemplary primary data processing device that may be utilized in connection with various embodiments of the present disclosure;

FIG. 2 is a block diagram illustrating a general implementation of an always-on local action controller; and

FIG. 3 is a flow chart of a general process for invoking an output action from an always-on local action controller according to another embodiment of the present disclosure.

### DETAILED DESCRIPTION

The detailed description set forth below in connection with the appended drawings is intended as a description of the several presently contemplated embodiments of an always-on local action controller and methods for invoking an output from the same. This description is not intended to represent the only form in which the embodiments of the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

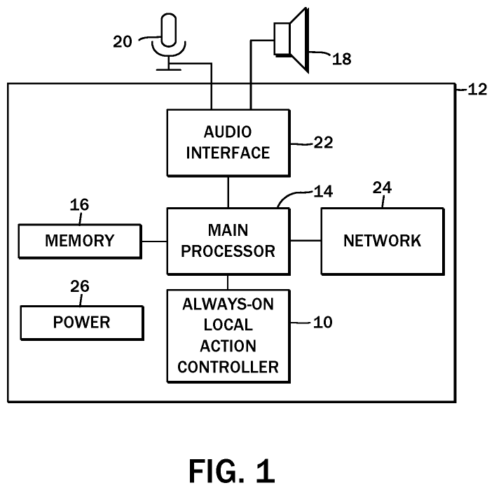

The present disclosure envisions multiple sensor fusion, and pattern detection based upon the data from such sensors, to evaluate invoking a local output action. With reference to the block diagram of FIG. 1, an always-on local action controller 10 may be incorporated into a primary data processing device 12. By way of example only and not of limitation, the primary data processing device 12 may be a smart speaker incorporating a virtual assistant with which users may interact via voice commands. In this regard, the primary data processing device 12 includes a main processor 14 that executes pre-programmed software instructions that correspond to various functional features of the primary data processing device 12. These software instructions, as well as other data that may be referenced or otherwise utilized during the execution of such software instructions, may be stored in a memory 16. As referenced herein, the memory 16 is understood to encompass random access memory as well as more permanent forms of memory.

In view of the primary data processing device 12 being a smart speaker, it is understood to incorporate a loudspeaker 18 that outputs sound from corresponding electrical signals applied thereto. Similarly, the primary data processing device 12 may incorporate a microphone 20 for capturing sound waves and transducing the same to an electrical signal. Both the loudspeaker 18 and the microphone 20 may be connected to an audio interface 22, which is understood to include at least an analog-to-digital converter (ADC) and a digital-to-analog converter (DAC). It will be appreciated by those having ordinary skill in the art that the ADC is used to convert the electrical signal transduced from the input audio waves to discrete-time sampling values corresponding to instantaneous voltages of the electrical signal. This digital data stream may be processed by the main processor, or a dedicated digital audio processor. The DAC, on the other hand, converts the digital stream corresponding to the output audio to an analog electrical signal, which in turn is applied to the loudspeaker 18 to be transduced to sound waves. There may be additional amplifiers and other electrical circuits that within the audio interface 22, but for the sake of brevity, the details thereof are omitted.

The primary data processing device 12 may also include a network interface 24, which serves as a connection point to a data communications network. This data communications network may be a local area network, the Internet, or any other network that enables an communications link between the primary data processing device 12 and a remote node. In this regard, the network interface 24 is understood to encompass the physical, data link, and other network interconnect layers. Although embodiments of the primary data processing device 12, and in particular the always-on local action controller 10 contemplate avoiding the need to utilize a remote/cloud system for further processing of inputs provided to the primary data processing device 12, some operations may require it, and hence the need to incorporate the network interface 24.

As the primary data processing device 12 is electronic, electrical power must be provided thereto in order to enable the entire range of its functionality. In this regard, the primary data processing device 12 includes a power module 26, which is understood to encompass the physical interfaces to line power, an onboard battery, charging circuits for the battery, AC/DC converters, regulator circuits, and the like. Those having ordinary skill in the art will recognize that implementations of the power module 26 may span a wide range of configurations, and the details thereof will be omitted for the sake of brevity.

Although certain specifics of the primary data processing device 12 have been described in the context of a smart speaker, the embodiments of the present disclosure contemplates the always-on local action controller 10 being utilized with other devices that are understood to be broadly encompassed within the scope of the primary data processing device 12. It may be any other autonomous device with different input and output modalities, such as remote control devices connectable to television sets, smartphones, smart wearable devices such as watches, bracelets, rings, and other jewelry, surveillance drones, alarm devices, health monitoring devices, and so on.

As will be described in further detail below, the always-on local action controller 10 may be implemented as a set of executable software instructions that correspond to various functional elements thereof. These instructions that are specific to the always-on local action controller 10 may be executed by the main processor 14, or with a dedicated processor that is specific to the always-on local action controller 10. To the extent the always-on local action controller 10 is implemented as a separate hardware module, some of the aforementioned components that are a part of the primary data processing device 12 such as memory may be separately incorporated.

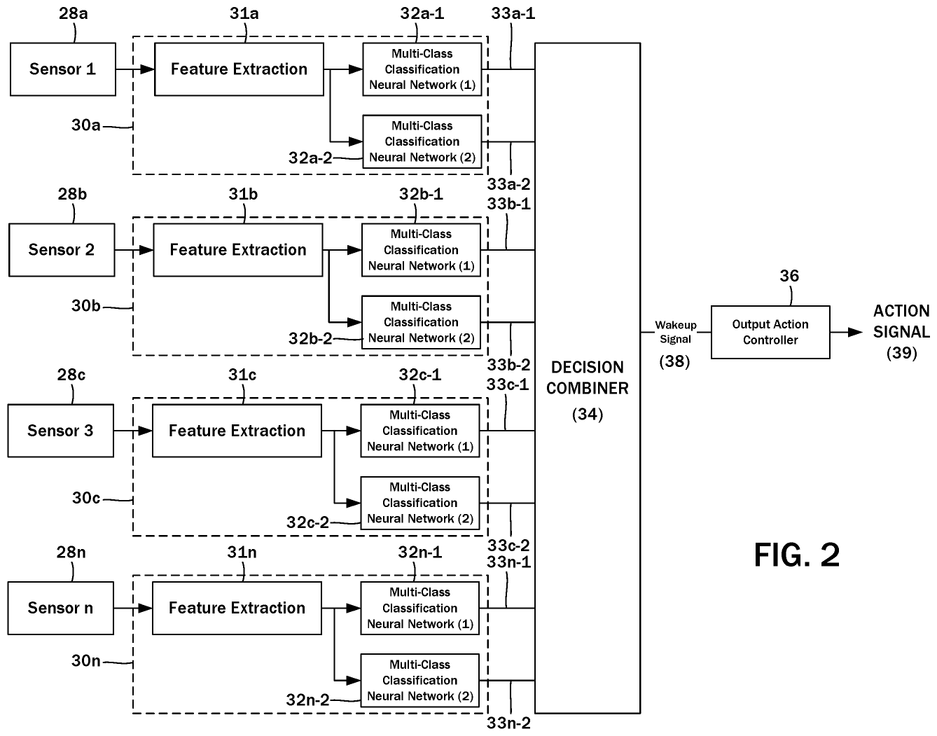

With reference to the block diagram of FIG. 2, the always-on local action controller 10 is understood to capture data from multiple sensors 28. In the illustrated example, there is a first sensor 28a, a second sensor 28b, and a third sensor 28c, as well as an additional indeterminate number of sensors 28n. As referenced herein, the sensor 28 is understood to be a device that captures some physical phenomenon and converts the same to an electrical signal that is further processed. For example, the sensor 28 may be a microphone/acoustic transducer that captures sound waves and converts the same to analog electrical signals, as discussed above. In another example, the sensor 28 may be an imaging sensor that captures incoming photons of light from the surrounding environment, and converts those photons to electrical signals that are arranged as an image of the environment. Furthermore, the sensor 28 may be motion sensor such as an accelerometer or a gyroscope that generates acceleration/motion/orientation data based upon physical forces applied to it. The sensors 28 as shown in the block diagram are understood to encompass all pertinent circuitry for conditioning and converting the environmental information into a data or streams of data upon which various processing operations may be applied. The embodiments of the present disclosure and not limited to any particular sensor or set of sensors, or any number of sensors.

The information captured by the plurality of sensors 28 may be used to determine whether a subsequent action is to be triggered from the always-on local action controller 10. According to an embodiment of the present disclosure, each of the sensors 28 are connected to a corresponding always-on data analytic neural network subsystem 30. Thus, connected to the first sensor 28a is a first always-on data analytic neural network subsystem 30a, connected to the second sensor 28b is a second always-on data analytic neural network subsystem 30b, connected to the third sensor 28c is a third always-on data analytic neural network subsystem 30c, and connected to an indeterminate sensor 28n is an indeterminate always-on data analytic neural network subsystem 30n.

In accordance with the illustrated embodiment, the always-on data analytic neural network subsystem 30 is comprised of a feature extractor 31, as well as one or more multi-class classification neural networks 32. Thus, the first always-on data analytic neural network subsystem 30a may include a first feature extractor 31a, the output of which is connected to a first multi-class classification neural network 32a-1 and a second multi-class classification neural network 32a-2. The second always-on data analytic neural network subsystem 30b may include a second feature extractor 31b, the output of which is connected to a first multi-class classification neural network 32b-1 and a second multi-class classification neural network 32b-2. Furthermore, the third always-on data analytic neural network subsystem 30c may include a third feature extractor 31c, the output of which is connected to a first multi-class classification neural network 32c-1 and a second multi-class classification neural network 32c-2. Along these lines, the indeterminate always-on data analytic neural network subsystem 30n may include a feature extractor 31n, the output of which is connected to a first multi-class classification neural network 32n-1 and a second multi-class classification neural network 32n-2. There may be more than two, or less than two multi-class classification neural networks 32 in a given always-on data analytic neural network subsystem 30.

The feature extractors 31 are understood to be specific to the sensors 28 to which they are connected. In one exemplary embodiment, the first sensor 28a may be the microphone for capturing audio. In this case, the feature extractor 31a may be a Mel-frequency cepstral coefficients (MFCCs) generator, Mel-Bands, per-channel energy normalized (PCEN) mel spectrograms or any suitable frequency domain representation. As will be appreciated by those having ordinary skill in the art, MFCCs are understood to be a representation of the power spectrum of a sound and may be derived using commonly known techniques. The derived coefficients are understood to correspond features of the captured audio. In another exemplary embodiment, the second sensor 28b may be a motion sensor such as an accelerometer or a gyroscope. In such case, the feature extractor 31b may be a simple router of time domain samples received from such accelerometer or gyroscope. Generally, the feature extractor 31 processes the incoming data from the sensors 28 to derive an initial understanding of the physical phenomena captured thereby. Accelerometers or gyroscopes are usually found in wearables to track human activity. Possible features that are extracted or collected from accelerometers or gyroscopes are the positional XYZ coordinates, velocity, inertia, different angles of rotations, etc.

The features derived by the individual feature extractors 31 are provided to the multi-class classification neural networks 32, which are also specific to the sensors 28 and the feature extractors 31 to which they are connected.

The multi-class classification neural networks 32 may be implemented in accordance with a variety of known configurations. One is a deep learning convolutional neural network (CNN), while another is the recurrent neural network (RNNs) in the form of long short-term memory networks (LSTMs) or gated recurrent units (GRU) for example. Still another implementation is multilayer perceptrons (MLPs). Any combination of these types of NN architectures can be used to build the inference network. These neural networks may be implemented with custom circuitry hardware that reduces the power consumption to less than 100 microwatts.

Each of the outputs from the neural networks 32 are connected to a decision combiner 34, with the event detections 33 from each block, that is, the sensor 28 and the always-on data analytic neural network subsystem 30 being processed to generate a final decision or action signal 39 from the multi-dimensional system. If the decision combiner 34 determines that the primary data processing device 12 is generate the action signal 39 based upon the pattern of the inputs provided thereto from the blocks, the wake signal 38 is generated to an output action controller 36. Depending on the specific use case, the action signal 39 may be handled locally or via a remote system. As will be described below, the action signal 39 may be, for example, enabling a beep generator to play back sound on the loudspeaker 18 integrated with the primary data processing device 12. In another example, the action signal 39 may be a notification to a receiving device via WiFi or Bluetooth through the network interface 24, with such actions triggering a reduction in volume, initiating a telephone call or video call to a contact, or turning on/off various connected devices such as lights or alarms.

The decision combiner 34 may be a simple logic circuit, or it may be a neural network combiner that may base the final action signal generation decision on different weighted factors applied to the various inputs. For example, a first neural network detects a wake word, command, context (Alexa, Ok google, Open door, hectic environment) based on voice/audio signals and a second neural network detects type of human activity based on data collected from sensors. Each of these networks provide specific metrics that could be combined to form a single metric for a final decision. The combination process can be in the form of a simple logic or more elaborate in the form of a third neural network. Sequential detection with priority, e.g.: microphone neural network detects via motor anomaly through acoustic analytics, then vibration sensor detects abnormal vibration movements, the decision maker mechanism will decide to notify user with siren or flashing lights.

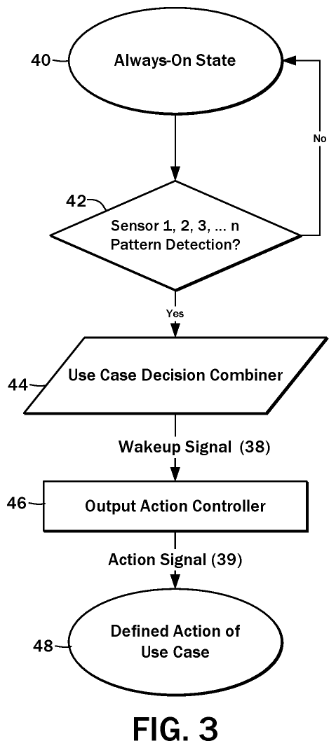

With reference to the flowchart of FIG. 3, based on the foregoing configuration of the always-on local action controller 10, one embodiment of a method for outputting an action command therefrom 2 begins with an always-on state 40. The data signal input to each sensor 28 is sent to sensor specific feature extraction block, the sensor specific inference circuitry acts on the detected feature and resultant pattern generated. In a decision block 42, the data from each of the sensors 28 is evaluated, and if a matching pattern is detected, proceeds to a decision combining step 44. Otherwise, the always-on state 40 is resumed. A wake signal 38 is generated and passed to the output action controller 36 a step 46. The predefined action for the particular use case is then executed in a step 48.

The always-on local action controller 10 and the process of generating the action signal from the primary data processing device 12 has been described in general terms, though a variety of specific use cases are contemplated in accordance with the embodiments of the present disclosure. In one use case, a remote controller for a television set may detect the sound of a crying infant, or breaking class, or any other alarming sound with always-on sound recognition. Based upon the detection of such events, the volume setting on the television set may be reduced. In another use case, a smartphone may detect breaking class or other such alarming sounds similarly with always-on sound recognition. The smartphone may then initiate a telephone call to a designated relative or other emergency contact. Alternatively, or in addition to the telephone call, a loud siren or other like alert to responding medical professionals may be generated. Various other health/safety emergencies may be handled via wearable devices such as watches, jewelry, and so on that can detect use distress and generating audio signals such as “HELP!” Notifications to nearby devices via Bluetooth or other connectivity modalities may be triggered to call 911 or other emergency contacts. In addition to triggering alarms based on captured sounds and images, motion detected by a smartphone or other sensor-equipped device may be configured to detect a change of state, such as walking up/down stairs, to free-falling. False positives may be avoided with the further fusion of audio data corresponding to a person in distress (e.g., screaming/yelling), with a combination of events being detected in order to alert an emergency contact.

Another use case contemplates a surveillance drone that may constantly monitor an area for possible intruders. A combination of image data and audio data may be evaluated by the always-on local action controller 10 incorporated into such a device, and when the conditions that correspond to an intrusion are detected, an alert may be generated to an owner's connected device, e.g., a smartphone.

A similar autonomous alarm device may be incorporated into a vehicle for activation while the vehicle ignition is turned off. Sounds that correspond to events such as breaking glass, screaming people, and other patterns may be detected, and alert signals may be generated to an owner's connected device. In addition to vehicle-installed devices, autonomous alarm devices may be installed in homes to detect sounds corresponding to a crackling fire. Again, the detection of such sounds may be achieved with an always-on sound recognition system. Based upon the detection of fire events, the fire department may be summoned via initiating a 911/emergency telecommunications session, or playing a loud siren alarm for alerting purposes.

Within the home as well as in health care providers (hospitals and other facilities), always-on monitoring systems with sound and image capturing features may be used to detect patient destress via sounds and facial expressions of pain. Based on the combination of data, an alarm may be generated autonomously to summon medical professionals.

In addition to the foregoing use cases, other like applications/uses cases for the always-on local action controller 10 are deemed to be within the purview of those having ordinary skill in the art.

The neural networks utilized in the embodiments of the present disclosure may be trained in a variety of ways. Generally, a neural network is a classifier that makes decisions on a sample space of mutually exclusive classes. Training is a form of supervised learning that requires the trainer to provide labeled data such that the neural network can learn the characteristics of a particular class. Specifically, the neural network is provided with data, such as a picture of a dog, or an audio sample, and its corresponding label, such as an identification of the dog, or the content of the audio sample. The multi-dimensional pattern detection classifier training method may be modularized to be multiple individual trainings, or one full end-to-end training.

The particulars shown herein are by way of example and for purposes of illustrative discussion of the embodiments of an always-on local action controller, and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. An always-on local action controller comprising:
one or more sensors each receptive to an external input, the respective external inputs being translatable to corresponding signals;
one or more always-on data analytic neural network subsystems each connected to a respective one of the one or more sensors and receptive to the signals outputted therefrom, an event detection being raised by a given one of the always-on data analytical neural network subsystems in response to a pattern of signal data corresponding to an event; and
a decision combiner connected to each of the one or more always-on data analytic neural network subsystems, an action signal being generated based upon an aggregate of the events provided thereby.

2. The always-on local action controller of claim 1, wherein the wake signal is output to an output action controller.

3. The always-on local action controller of claim 1, wherein one of the one or more sensors is a microphone and the external input is an audio wave.

4. The always-on local action controller of claim 1, wherein one of the one or more sensors is an image sensor and the external input is light photons corresponding to an image.

5. The always-on local action controller of claim 1, whereon one of the or more sensors is a motion sensor, and the external input is physical motion applied thereto.

6. The always-on local action controller of claim 1, wherein each of the always-on data analytic neural network subsystems includes:
a feature extractor connected to the corresponding one of the sensors and receptive to the signals outputted therefrom, feature data associated with the signals being generated by the feature extractor; and
a neural network connected to the feature extractors, the event detection being generated from patterns of the feature data generated by the feature extractor.

7. The always-on local action controller of claim 6, wherein the neural network is a multi-class classifier neural network.

8. The always-on local action controller of claim 7, wherein the multi-class classifier neural network is selected from a group consisting of: a convolutional neural network (CNN), a long short term memory network (LSTM), a recurrent neural network (RNN), and a multilayer perceptron (MLP).

9. The always-on local action controller of claim 7, wherein the neural network consume less than 100 microwatts of power while in operation.

10. The always-on local action controller of claim 1, wherein the decision combiner is implemented as a logic circuit accepting as input each of the event detections provided by the one or more always-on data analytic neural network subsystems and generates an output of the action signal.

11. The always-on local action controller of claim 1, wherein the decision combiner is implemented as a neural network.

12. A method for outputting an action command from an always-on controller, the method comprising:
receiving one or more external inputs on respective ones of sensors, the external inputs being converted to corresponding signals thereby;
detecting one or more events from the signals of the external inputs on a respective one of always-on data analytic neural network subsystems; and
combining the detected events to generate an action signal based upon an aggregate of the detected events.

13. The method of claim 12, wherein the detecting of the one or more events further includes:
extracting feature data sets from each of the signals;
generating inference decisions for each of the extracted feature data sets based upon individual patterns thereof, the inference decisions being output as the detected events.

14. The method of claim 12, wherein one of the external inputs is audio and the one of the sensors is a microphone.

15. The method of claim 12, wherein one of the external inputs is light photons corresponding to an image and the one of the sensors is an imaging sensor.

16. The method of claim 12, wherein one of the external inputs is physical motion applied to the computing device and the one of the sensors is a motion sensor.

17. The method of claim 12, wherein the always-on data analytic neural network subsystems each include an independent multi-class classifier neural network.

18. The method of claim 17, wherein the multi-class classifier neural network is selected from a group consisting of: a convolutional neural network (CNN), a long short term memory network (LSTM), a recurrent neural network (RNN), and a multilayer perceptron (MLP).

19. The method of claim 17, wherein the multi-class classifier neural networks are independently trained, with the combining step being performed by a logic circuit accepting as input each of the event detections.

20. An article of manufacture comprising a non-transitory program storage medium readable by a computing device, the medium tangibly embodying one or more programs of instructions executable by the computing device to perform a method for outputting an action command from an always-on controller, the method comprising:
receiving one or more external inputs on respective ones of sensors, the external inputs being converted to corresponding signals thereby;
detecting one or more events from the signals of the external inputs on a respective one of always-on data analytic neural network subsystems; and
combining the detected events to generate an action signal based upon an aggregate of the detected events.
